(19) United States
(12) Patent Application Publication
(10) Pub. No.: US 2018/0303140 A1
(43) Pub. Date: Oct. 25, 2018

(54) AGGREGATED SAUERKRAUT FOODSTUFF HAVING A PREDETERMINED SHAPE

(71) Applicants: Ida Brown, Toledo, OH (US); Derek Brown, Toledo, OH (US)

(72) Inventors: Ida Brown, Toledo, OH (US); Derek Brown, Toledo, OH (US)

(21) Appl. No.: 15/956,067

(22) Filed: Apr. 18, 2018

Related U.S. Application Data
(60) Provisional application No. 62/487,282, filed on Apr. 19, 2017.

(51) Int. Cl. A23L 19/20; A23P 20/10

(52) U.S. Cl. CPC A23L 19/20; A23L 5/11; A23P 20/10

(57) ABSTRACT

Disclosed are fried, edible sauerkraut foodstuff(s) having a predetermined shape. The foodstuff includes (a) shredded cheese and cream cheese dispersed throughout the foodstuff (b) a meat product, diced onion, and diced oven bell pepper heterogeneously dispersed in the foodstuff; (c) seasoning homogeneously dispersed throughout the foodstuff and (d) shredded sauerkraut. The shredded sauerkraut of the foodstuff is aggregated and adhered together by the shredded cheese and/or cream cheese to form the fried, edible sauerkraut foodstuff having a predetermined shape with the meat product heterogeneously dispersed throughout the foodstuff.

### TECHNICAL HELD

The present invention relates generally to the field of food and food preparation, and more particularly, to aggregated sauerkraut foodstuffs having a predetermined shape.

### BRIEF SUMMARY

It is an object of the invention to provide delicious and highly desired sauerkraut containing foodstuffs/products. Thus, disclosed is a fried, edible sauerkraut foodstuff having a predetermined shape, the foodstuff including (a) shredded cheese and cream cheese dispersed throughout the foodstuff; (b) a meat product, diced onion, and diced green bell pepper in the foodstuff; (c) seasoning homogeneously dispersed throughout the foodstuff; and (d) shredded sauerkraut. In the fried, edible sauerkraut foodstuff, the shredded sauerkraut is aggregated and adhered together by the shredded cheese and/or cream cheese to form the fried, edible sauerkraut foodstuff having a predetermined shape with the meat product, diced onion, and diced green bell pepper heterogeneously dispersed throughout the foodstuff. In certain aspects, the shredded cheese, cream cheese, or a combination thereof are homogeneously dispersed or heterogeneously dispersed throughout the foodstuff.

In certain aspects, the predetermined shape is spherical, semi-spherical, cubed, or semi-cubed.

Also disclosed are methods of making the fried, edible sauerkraut foodstuff having a predetermined shape. For example, this method includes (a) providing shredded sauerkraut, shredded cheese, cream chees, a meat product, diced onion, diced green bell pepper, and seasoning; (b) mixing the shredded sauerkraut, shredded cheese, cream cheese, a meat product, diced onion, diced green bell pepper, and seasoning together thereby forming a mixture such that: (i) the shredded sauerkraut is aggregated and adhered to ether by the shredded cheese and/or cream cheese in the mixture; (ii) the seasoning is homogeneously dispersed throughout the mixture; and (iii) the meat product, diced onion, and diced green bell pepper are heterogeneously dispersed throughout the mixture; (c) rolling the mixture of step (b) thereby forming a spherical-shaped foodstuff; (d) coating the spherical-shaped foodstuff of step (c) with flour and breadcrumbs throughout an outer periphery of the spherical-shaped foodstuff thereby forming a coated spherical-shaped foodstuff, (e) refrigerating the spherical-shaped foodstuff between 32° F. to 40° F. for 8 to 12 hours thereby forming a solidified coated spherical-shaped foodstuff, and (f) after step (e), frying the solidified coated spherical-shaped foodstuff at a temperature ranging from about 330° F. to 400° F., more preferably from 355° F. to 375° F. for 3 to 4 minutes thereby forming the spherical-shaped fried, edible sauerkraut foodstuff. In certain aspects, steps (a)-(f) of the disclosed method are performed sequentially.

Embodiments of the invention can include one or more or any combination of the above features and configurations.

Additional features, aspects and advantages of the invention will be set forth in the detailed description, which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed.

### DETAILED DESCRIPTION

The present invention will now be described more fully hereinafter. The invention maybe embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Disclosed are edible sauerkraut foodstuffs that are preferably fried and have a predetermined shape (e.g., a spherical, semi-spherical, cubed or semi-cubed shaped). In certain aspects, the fried, edible sauerkraut foodstuff includes (a) shredded cheese and cream cheese dispersed throughout the foodstuff; (b) a meat product, diced onion and diced green bell pepper in the foodstuff; (c) seasoning homogeneously dispersed throughout the foodstuff; and (d) shredded sauerkraut. To ensure proper formation and presentation of the foodstuff, the shredded sauerkraut is aggregated and adhered together by the shredded cheese and/or cream cheese to form the fried, edible sauerkraut foodstuff having a predetermined shape with the meat product, diced onion and diced green bell pepper heterogeneously dispersed throughout the foodstuff. In certain aspects, the shredded cheese, cream cheese, or a combination thereof are homogeneously dispersed or heterogeneously dispersed throughout the foodstuff. The edible sauerkraut foodstuff(s) are spherical, semi-spherical, cubed, or semi-cubed shape, and are most preferably spherical-shaped (i.e., rounded into balls) having a diameter ranging from ⅛ of an inch to 2 inches, ⅛ of an inch to 1 ¾ inches, ⅛ of an inch to 1 ½ inches, ½ of an inch to 2 inches, ½ of an inch to 1 ¾ inches, ½ of an inch to 1 ½ inches and ½ of an inch to 1 inch.

In certain aspects, the edible sauerkraut foodstuffs include a flour coating on the outer periphery of the foodstuff as well as breadcrumbs heterogeneously dispersed throughout the outer periphery of the foodstuff.

In certain aspects, the flour coating of the outer periphery of the foodstuff is at least partially fried and extends along the outer circumference of the spherical-shaped foodstuff, and in further aspects, the outer periphery of the foodstuff is fully fried (having a brown surface/appearance) and extends around the outer circumference of the spherical-shaped foodstuff and inwardly to the core/origin of the spherical-shaped foodstuff.

In certain aspects, at least any three of the shredded cheese, cream cheese, meat product, diced onion, diced green bell pepper and shredded sauerkraut comprise an inner core of the foodstuff in which the inner core being at least partially fried. In additional aspects, the shredded cheese, cream cheese, meat product, diced onion, diced green bell pepper and shredded sauerkraut may each comprise an inner core of the foodstuff in which the inner core is at least partially fried. In further aspects, both the outer periphery and the inner core of the foodstuff may be fried.

The fried portions of the food stuff maybe formed by frying the foodstuff in cooking oil (e.g., vegetable oil such as canola oil, olive oil, palm oil, soybean oil, and/or peanut oil) at a temperature ranging from about 330° F. to 400° F., more preferably from 355° F. to 375° F. for 3 to 4 minutes. For example, the partially fried periphery of the foodstuff is preferably formed by flying the foodstuff in cooking oil at a temperature ranging from 355° F. to 375° F. for 3 to 4 minutes.

The disclosed meat products included in the foodstuff are at least one of diced pork sausage, diced turkey sausage or diced beef sausage. In preferred aspects, the meat product is diced pork sausage. In certain aspects, the meat product(s) is pre-cooked before mixing with the shredded cheese, cream cheese and shredded sauerkraut.

The disclosed seasoning includes paprika, chili powder or a combination thereof.

Also disclosed herein are methods of making the edible sauerkraut foodstuffs including, but not limited to, edible sauerkraut foodstuffs that are preferably fried and have a predetermined shape. These foodstuffs can include, for example, aspherical or semi-spherical shaped fried, edible sauerkraut foodstuff. The methods of making these edible sauerkraut foodstuffs (e.g., spherical or semi-spherical-shaped fried, edible sauerkraut foodstuff) include (a) providing shredded sauerkraut, shredded cheese, cream cheese, a meat product, diced onion, diced green bell pepper and seasoning; (b) mixing the shredded sauerkraut, shredded cheese, cream cheese, a meat product, diced onion, diced green bell pepper and seasoning together thereby forming a mixture such that (i) the shredded sauerkraut is aggregated and adhered together by the shredded cheese and/or cream cheese in the mixture; (ii) the seasoning is homogeneously dispersed throughout the mixture; and (iii) the meat product, diced onion, and diced green bell pepper are heterogeneously dispersed throughout the mixture; (c) rolling the mixture of step (b) thereby forming a spherical or semi-spherical shaped foodstuff; (d) coating the spherical or semi-spherical shaped foodstuff of step (c) with flour and breadcrumbs throughout an outer periphery of the spherical or semi-spherical shaped foodstuff thereby forming a coated spherical or semi-spherical shaped foodstuff; (e) refrigerating the coated spherical or semi-spherical shaped foodstuff between 32° F. to 40° F. for 8 to 12 hours thereby forming a solidified coated spherical or semi-spherical shaped foodstuff; and (f) after step (e), frying in a cooking oil the solidified coated spherical or semi-spherical shaped foodstuff at a temperature ranging from about 330° F. to 400° F., more preferably from 355° F. to 375° F. for 3 to 4 minutes thereby forming the spherical or semi-spherical shaped fried, edible sauerkraut foodstuff. The spherical or semi-spherical edible sauerkraut foodstuffs have a diameter ranging from ⅛ of an inch to ¾ of an inch, and more preferably from ¼ of an inch to ½ of an inch. In certain aspects, steps (a)-(f) of the disclosed method are performed sequentially.

In certain aspects, the rolling of step (c) includes placing the mixture of step (b) on a curved object (such as a tablespoon or a teaspoon) and rolling the mixture on the curved object to form a spherical or semi-spherical shaped foodstuff.

In certain aspects, the outer periphery of the spherical or semi spherical shaped fried, edible sauerkraut foodstuff is at least partially fried. In additional aspects, at least any three of the shredded cheese, cream cheese, meat product, diced onion, diced green bell pepper and shredded sauerkraut comprise an inner core of the spherical or semi-spherical shaped fried, edible sauerkraut foodstuff and the inner core is at least partially fried. The fried portions of the food stuff may be formed by frying the foodstuff in cooking oil (vegetable oil such as canola oil, olive oil, palm oil, soybean oil, and/or peanut oil) at the above discussed times and temperatures.

As discussed above, the meat products used in the disclosed methods include at least one of diced pork sausage, diced turkey sausage, or diced beef sausage. In preferred aspects, the meat product is diced pork sausage. In certain aspects, the meat product(s) is pre-cooked before mixing with the shredded cheese, cream cheese and shredded sauerkraut.

The seasoning used in the disclosed methods include at least paprika and chili powder.

In certain aspects, the disclosed methods further include, after step (a) but before step (b), dicing the shredded sauerkraut, shredded cheese and meat product.

In certain aspects, the disclosed methods further include during step (d) infusing the spherical-shaped foodstuff with milk by rolling the spherical-shaped foodstuff in milk. In certain aspects, the milk is 2% milk.

In certain aspects, the disclosed methods further include, after step (d) but before step (e), infusing the coated spherical-shaped foodstuff with milk by rolling the coated spherical-shaped foodstuff in milk.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A fried, edible sauerkraut foodstuff having a predetermined shape, the foodstuff comprising:
(a) shredded cheese and cream cheese dispersed throughout the foodstuff;
(b) a meat product, diced onion and diced green bell pepper that are heterogeneously dispersed throughout the foodstuff;
(c) seasoning that is homogeneously dispersed throughout the foodstuff; and
(d) shredded sauerkraut, wherein:
the shredded sauerkraut is aggregated and adhered together by the shredded cheese and/or cream cheese to form the fried, edible sauerkraut foodstuff having a predetermined shape.

2. The foodstuff of claim 1, further comprising a flour coating the outer periphery of the foodstuff with breadcrumbs heterogeneously dispersed thereon.

3. The foodstuff of claim 2, wherein the predetermined shape is spherical.

4. The foodstuff of claim 3, wherein the flour coating of the outer periphery of the foodstuff is at least partially fried and extends along the outer circumference of the spherical-shaped foodstuff.

5. The foodstuff of claim 4, wherein at least any three of the shredded cheese, cream cheese, meat product, diced onion, diced green bell pepper and shredded sauerkraut comprise an inner core of the foodstuff and the inner core being at least partially fried.

6. The foodstuff of claim 5, wherein the partially fried outer periphery of the foodstuff is formed by flying the foodstuff in cooking oil at a temperature range from 355°F. to 375° F. for 3 to 4 minutes.

7. The foodstuff of claim 6, wherein the meat product comprises diced pork sausage.

8. The foodstuff of claim 7, wherein the seasoning comprises paprika and chili powder.

9. A method of making a spherical-shaped fried, edible sauerkraut foodstuff, the method comprising:
(a) providing shredded sauerkraut, shredded cheese, cream cheese, a meat product, diced onion, diced green bell pepper and seasoning;
(b) mixing the shredded sauerkraut, shredded cheese, cream cheese, a meat product, diced onion and diced green bell pepper, and seasoning together thereby forming a mixture such that:
(i) the shredded sauerkraut is aggregated and adhered together by the shredded cheese and or cream cheese in the mixture;
(ii) the seasoning is homogeneously dispersed throughout the mixture; and
(iii) the meat product, diced onion, and diced green bell pepper are heterogeneously dispersed throughout the mixture;
(e) rolling the mixture of step (b) thereby forming a spherical-shaped foodstuff;
(d) coating the spherical-shaped foodstuff of step (e) with flour and breadcrumbs throughout an outer periphery of the spherical-shaped foodstuff thereby forming a coated spherical-shaped foodstuff;
(c) refrigerating the spherical-shaped foodstuff between 32 to 40° F. for 8 to 12 hours thereby forming a solidified coated spherical-shaped foodstuff; and
(f) after step (e), frying the solidified coated spherical-shaped foodstuff at a temperature ranging from 355° F. to 375° F. for 3 to 4 minutes thereby forming the spherical-shaped fried, edible sauerkraut foodstuff.

10. The method of claim of claim 9, wherein the outer periphery of the spherical-shaped fried, edible sauerkraut foodstuff is at least partially fried.

11. The method of claim 10, wherein at least any three of the shredded cheese, cream cheese, meat product, diced onion, diced green bell pepper and shredded sauerkraut comprise an inner core of the spherical-shaped fried, edible sauerkraut foodstuff and the inner core is at least partially fried.

12. The method of claim 11, wherein the meat product comprises diced pork sausage.

13. The method of claim 12, wherein the seasoning comprises paprika and chili powder.

14. The method of claim 13, further comprising, after step (a) but before step (b), dicing the shredded sauerkraut, shredded cheese and meat product.

15. The method of claim 14, further comprising, during step (d) infusing, the spherical-shaped foodstuff with milk by rolling the spherical-shaped foodstuff in milk.

16. The method of claim 14, further comprising, after step (d) but before step (e), infusing the coated spherical-shaped foodstuff with milk by rolling the coated spherical-shaped foodstuff in milk.

17. The method of claim 9, wherein steps (a)-(f) are performed sequentially.
